(19) United States
(12) Patent Application Publication
(10) Pub. No.: US 2018/0102908 A1
(43) Pub. Date: Apr. 12, 2018

(54) FINE GRAIN RECONFIGURABLE BUILDING BLOCK FOR IC PROTECTION AND OBFUSCATION

(71) Applicant: Tyfone, Inc., Portland, OR (US)

(72) Inventor: Siva G. Narendra, Portland, OR (US)

(73) Assignee: Tyfone, Inc., Portland, OR (US)

(21) Appl. No.: 15/290,672

(22) Filed: Oct. 11, 2016

(51) Int. Cl. H04L 9/32; G06F 17/50; H04L 9/06; H03K 19/177; H03K 19/20; H03K 19/0948; H03K 19/003

(52) U.S. Cl. CPC H04L 9/3278; G06F 17/5081; G06F 17/5045; H03K 19/00315; H03K 19/17728; H03K 19/20; H03K 19/0948; H04L 9/06

(57) ABSTRACT

A reconfigurable logic cell may implement either a NAND function or a NOR function based on the state of a selection bit. A reconfiguration tool modifies an integrated circuit design description to include reconfigurable logic cells, a key management unit, and a physically unclonable function. The modified design description is obfuscated to all except for those that know the correct selection bits to apply to the reconfigurable logic cells.

### FIELD

The present invention relates generally to integrated circuits, and more specifically to the design and manufacture of integrated circuits.

### BACKGROUND

Integrated circuits are typically designed by one party and manufactured by another. For example, an application specific integrated circuit (ASIC) may be designed by a company that intends to use the ASIC in a product, and the company may contract with a foundry to manufacture the ASIC. In this scenario, the company is the foundry's customer.

The foundry customer typically provides the foundry with a design description that the foundry uses to manufacture the ASIC. The design description typically includes sufficient information to allow intellectual property (IP) within the ASIC to be pirated if the design description were to fall into the wrong hands.

As foundries become geographically decoupled from customers (e.g., Asia vs. US and Europe), the customer's ability to control access to the design description is reduced, and the threat of piracy grows.

Previous approaches to reduce piracy include obfuscation of design descriptions by adding logic barriers within the design description. See, for example, A. Baumgarten, A. Tyagi, and J. Zambreno, “Preventing IC Piracy Using Reconfigurable Logic Barriers,” IEEE Design and Test of Computers, vol. 27, no. 1, pp. 66-75, 2010. Logic barriers provide coarse grain control of information flow into logic paths within the integrated circuit represented by the design description. Logic barrier modules are placed between logic blocks and provide inverting or non-inverting data paths. This prevents access to the design in the field, but a highly motivated adversary in a foundry may be able to judge the majority of the logic and reverse engineer the rest of the integrated circuit.

### BRIEF DESCRIPTION OF THE DRAWINGS

FIG. 1 shows a reconfigurable logic cell;

FIG. 2 shows an example implementation of a reconfigurable logic cell;

FIG. 3 shows a reconfigurable logic block implementing a sum of products;

FIG. 4 shows a reconfigurable logic block implementing a product of sums;

FIGS. 5 and 6 show three input reconfigurable logic cells built from multiple two input reconfigurable logic cells;

FIGS. 7 and 8 show reconfigurable logic blocks that include reconfigurable logic cells;

FIG. 9 shows an integrated circuit that includes reconfigurable logic, a key management unit, and a physically unclonable function;

FIG. 10 shows a key management unit;

FIG. 11 shows a design process for an integrated circuit that includes reconfigurable logic;

FIG. 12 shows an example electronic design automation (EDA) computer system for designing integrated circuits with reconfigurable logic;

FIG. 13 shows an Intellectual Property owner providing encrypted reconfiguration keys to integrated circuits;

FIG. 14 shows an integrated circuit with embedded storage for an encrypted reconfiguration key; and

FIGS. 15-18 show flowcharts of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

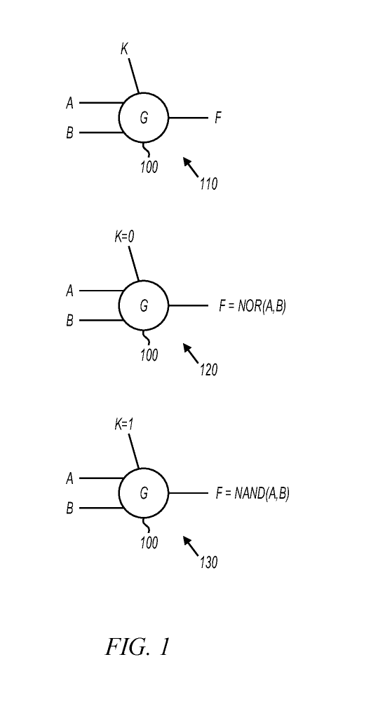

FIG. 1 shows a reconfigurable logic cell. Reconfigurable logic cell 100 implements logical function F of two inputs A and B. Reconfigurable logic cell also includes a selection mechanism that is responsive to the selection bit K. As shown at 110, reconfigurable logic cell 100 (also referred to as building block G) implements F (K,A,B). The output F will either compute NAND of the inputs A, B or NOR of the inputs A, B depending on the value of the selection bit K.

When K=0, reconfigurable logic cell 100 implements a NOR gate as shown at 120 as F=NOR(A,B). When K=1, reconfigurable logic cell 100 implements a NAND gate as shown at 130 as F=NAND(A,B).

Various embodiments of the invention build larger logic functions using reconfigurable logic cell 100 as a building block. IP protection comes from the fact that without knowing the selection bit value K, the foundry will not know the logic function at the gate level and therefore will also not know the logic function for the entire logic path. In addition, the uniformity of reconfigurable logic cell 100 brings layout obfuscation for the gate's functionality. One of the potential side benefits of the reconfigurable logic cell is the uniform and possibly identical layout for each unit cell that has the potential to increase yield of nanotechnology nodes that prefer uniformity. In these embodiments, the logic paths whose IP needs to be protected include identical gates that are fine-grain reconfigurable on a gate by gate basis.

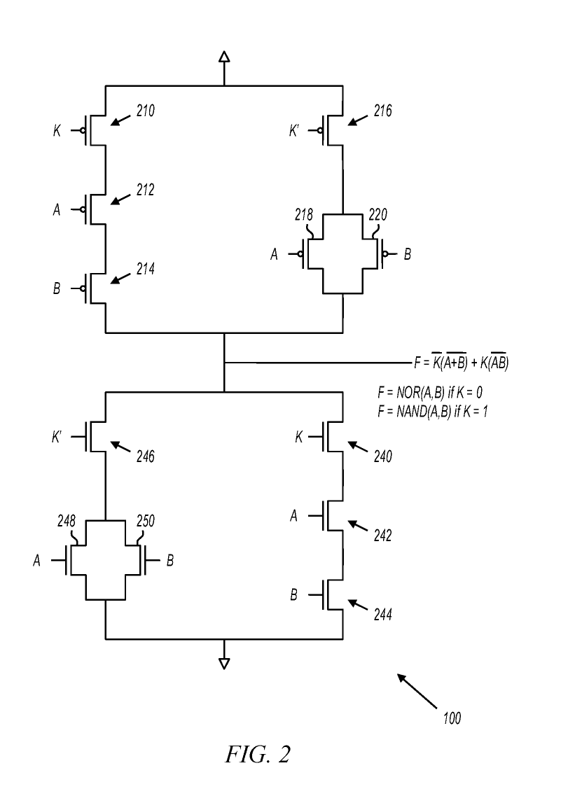

FIG. 2 shows an example implementation of a reconfigurable logic cell. FIG. 2 shows a complementary metal oxide semiconductor (CMOS) implementation of the reconfigurable logic cell 100. Reconfigurable logic cell 100 implements a NAND function if the selection bit K=1 (K′=0) and implements a NOR function if the selection bit K=0 (K′=1).

Reconfigurable logic cell 100 includes PMOS transistors 210, 212, 214, 216, 218, and 220. Reconfigurable logic cell 100 also includes NMOS transistors 240, 242, 244, 246, 248, and 250. Transistors 210, 216, 240, and 246 provide a selection mechanism within reconfigurable logic cell 100. The selection mechanism selects between NAND and NOR functionality based on the state of the selection bit K.

For example, when selection bit K=0 (K′=1), transistors 210 and 246 are on, and transistors 216 and 240 are off In this configuration, transistors 212, 214, 248, and 250 implement a NOR function. Also for example, when selection bit K=1 (K′=0), transistors 216 and 240 are on, and transistors 210 and 246 are off. In this configuration, transistors 218, 220, 242, and 244 implement a NAND function.

This example implementation of reconfigurable logic cell 100 not only maintains uniformity across all gates, there is uniformity between the NMOS and the PMOS networks making signal routing easier for this complex gate. Apart from the potential yield side benefit provided by the layout uniformity, under the state when selection transistors 210, 216, 240, and 246 are forced to be off, reconfigurable logic cell 100 enters a power gated state to reduce sub-threshold leakage currents.

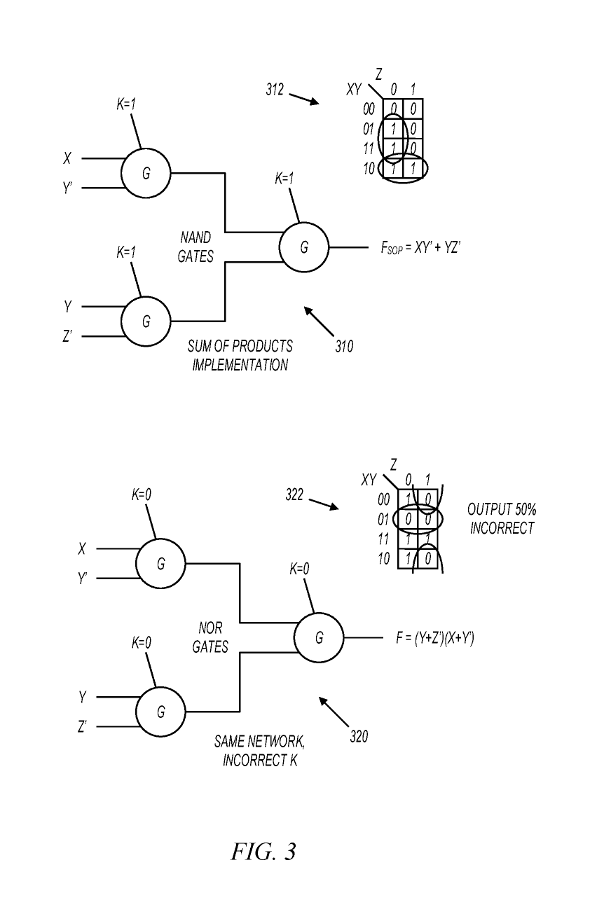

FIG. 3 shows a reconfigurable logic block implementing a sum of products. An example Boolean function to implement is defined in FIG. 3 at 312. This function is implemented as a sum-of-products (SOP) using two stages of three 2-input NAND gates configured with K=1 for all three building block G thereby implementing the SOP as shown at 310. In the example design shown at 310, all three building blocks in this SOP can share the same selection bit K.

If an adversary were to guess that K=0 for these three building blocks, each of the reconfigurable logic cells would implement NOR gates, and the network shown at 320 would result. The resulting logic function is shown at 322, where it can be seen that the output would be incorrect 50% of the time. This is because the reconfigurable logic block would implement a product-of-sums using a network that should be implementing a sum-of-products.

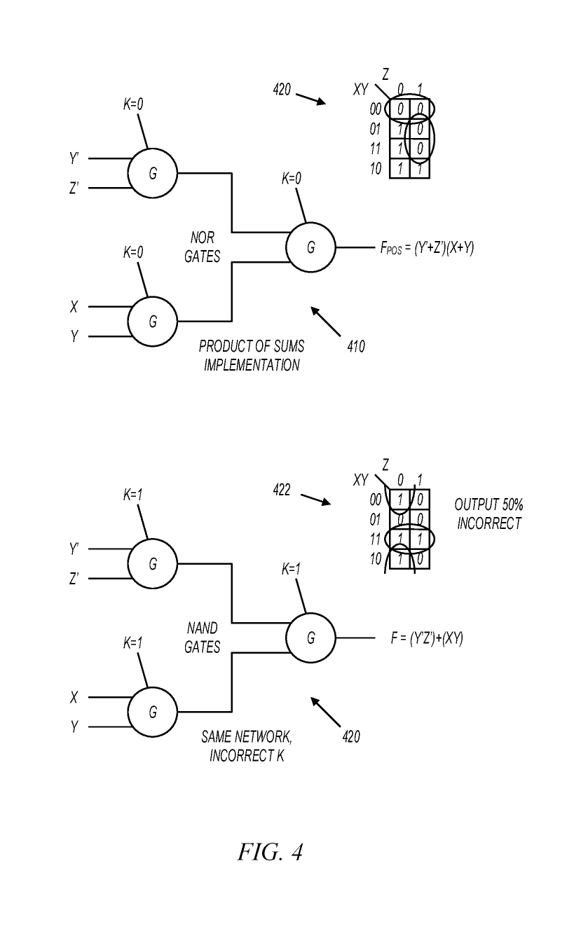

FIG. 4 shows a reconfigurable logic block implementing a product of sums. Reconfigurable logic block 410 implements as a product-of-sums the same logical function that logic block 310 (FIG. 3) implements as a sum-of-products. The logical function is shown at 420. The only difference between the functions shown at 312 and 420 is that minterms are selected at 312 and maxterms are selected at 420.

Reconfigurable logic block 410 implements the function shown at 420 as a product-of-sums (POS) using two stages of three 2-input NOR gates configured with K=0 for all three building block G. In the example design shown at 410, all three building blocks in this POS can share the same selection bit K.

If an adversary were to guess that K=1 for these three building blocks, each of the reconfigurable logic cells would implement NAND gates, and the network shown at 420 would result. The resulting logic function is shown at 422, where it can be seen that the output would be incorrect 50% of the time. This is because the reconfigurable logic block would implement a sum-of-products using a network that should be implementing a product-of-sums.

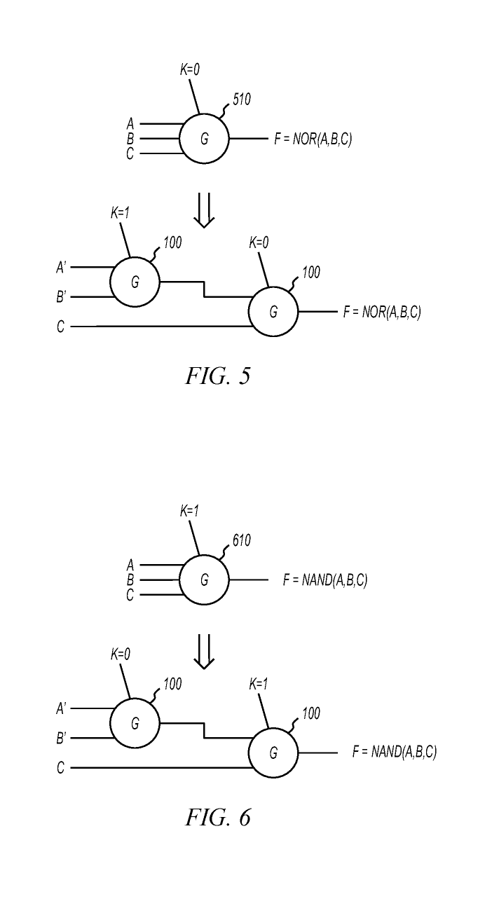

FIGS. 5 and 6 show three input reconfigurable logic cells built from multiple two input reconfigurable logic cells. A reconfigurable logic cell that implements a NOR gate having three inputs is shown in FIG. 5 at 510. Reconfigurable logic cell 510 receives three inputs (A, B, C) and implements the function F=NOR(A,B,C). The three input reconfigurable logic cell at 510 can be implemented using two two-input reconfigurable logic cells 100, with a first cell implementing NAND(A′,B′), and the second cell implementing NOR(C,NAND(A′,B′)). The result as shown in FIG. 5 is NOR(A,B,C).

A reconfigurable logic cell that implements a NAND gate having three inputs is shown in FIG. 6 at 610. Reconfigurable logic cell 610 receives three inputs (A, B, C) and implements the function F=NAND(A,B,C). The three input reconfigurable logic cell at 610 can be implemented using two two-input reconfigurable logic cells 100, with a first cell implementing NOR(A′,B′), and the second cell implementing NAND(C,NOR(A′,B′)). The result as shown in FIG. 6 is NAND(A,B,C).

Note that the first stage in both FIGS. 5 and 6 requires inverted inputs and the value of K is not the same for every reconfigurable logic cell in the network. In some embodiments, inverters are included within the reconfigurable logic cell to invert the appropriate inputs and the selection bit as needed. In other embodiments, complementary signals are provided as needed by circuits that drive the reconfigurable logic cell.

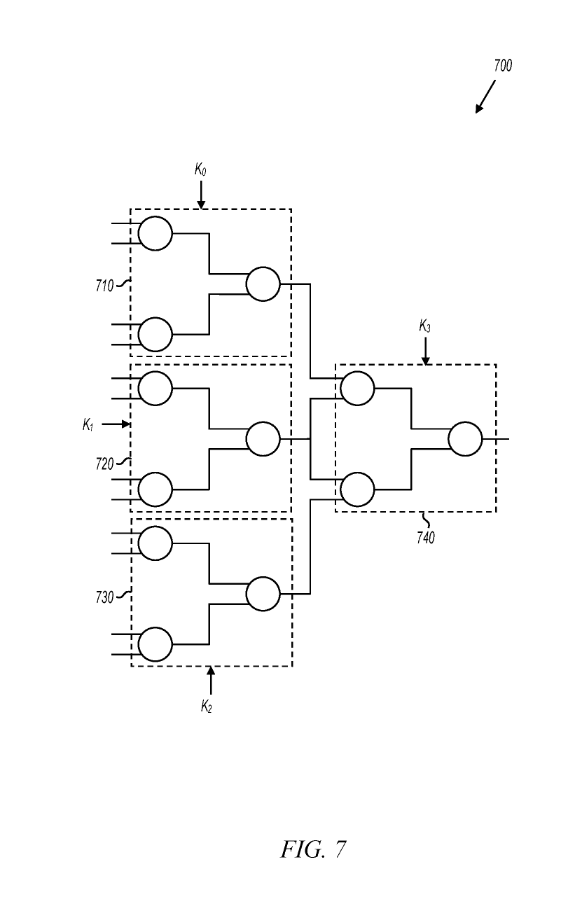

FIGS. 7 and 8 show reconfigurable logic blocks that include reconfigurable logic cells. FIG. 7 shows reconfigurable logic blocks 710, 720, 730, and 740. Each of the reconfigurable logic blocks includes three reconfigurable logic cells represented by circles.

In embodiments represented by FIG. 7, each reconfigurable logic cell within block 710 receives selection bit K₀; each reconfigurable logic cell within block 720 receives selection bit K₁; each reconfigurable logic cell within block 730 receives selection bit K₂; and each reconfigurable logic cell within block 710 receives selection bit K₃. Each of the reconfigurable logic blocks 710, 720, 730, and 740 may implement a sum-of-products or product-of-sums depending on the value of the selection bit Kᵢ.

Each reconfigurable logic block shown in FIG. 7 includes three two-input reconfigurable logic cells, but this is not a limitation of the present invention. For example, any number of reconfigurable logic cells may be included in a reconfigurable logic block, and reconfigurable logic cells may have any number of inputs.

FIG. 8 shows reconfigurable logic blocks 810, 820, 830, and 840. Reconfigurable logic block 810 includes six reconfigurable logic cells that share a single selection bit K₀; reconfigurable logic block 820 includes four reconfigurable logic cells that share a single selection bit K₁; reconfigurable logic block 830 includes one reconfigurable logic cell that receives selection bit K₂; and reconfigurable logic block 840 includes one reconfigurable logic cell that receives selection bit K₃.

The logic network in FIG. 8 shows that in some embodiments, selection bits for reconfigurable logic cells may drive the implementation of sum-of-products, product-of-sums, or any other random logic pattern.

Any number of reconfigurable logic cells may be grouped to receive a single selection bit K. In some embodiments, every single reconfigurable logic cell within an integrated circuit has its own separate routing of selection bit K, and in other embodiments, reconfigurable logic cells are grouped and the number of selection bits K is smaller than the number of reconfigurable logic cells. If there are N gates then there will be n selection bits K_{[0-n]} where n<=N−1. K_{[0-n]} is referred to herein as a “reconfiguration key.”

Larger values of n (larger reconfiguration keys) provide better obfuscation and security but also result in larger routing, power, and delay overhead in the integrated circuit.

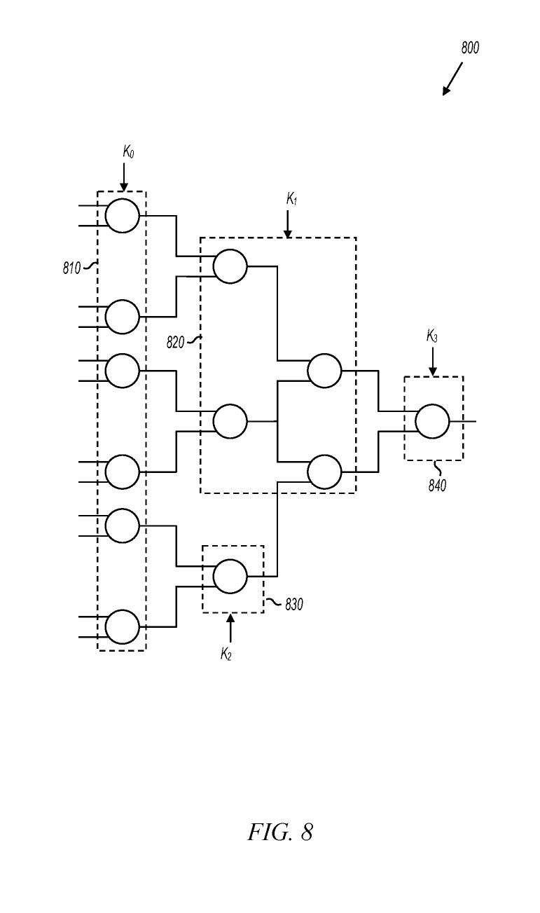

FIG. 9 shows an integrated circuit that includes reconfigurable logic, a key management unit, and a physically unclonable function. Integrated circuit 900 includes reconfigurable logic 910, key management unit 930, and physically unclonable function (PUF) 920. Key management unit 930 includes key generator 932, decryptor 934, and public/private key storage 936.

Reconfigurable logic 910 includes one or more logic blocks that have been partitioned into reconfigurable logic blocks that are implemented using reconfigurable logic cells 100. For example, reconfigurable logic 910 may include reconfigurable logic blocks such as those shown in FIGS. 3-8. Reconfigurable logic block 910 receives reconfiguration key K_{[0-n]} and routes individual selection bits Kᵢ to individual reconfigurable logic blocks and/or cells. Key management unit 930 provides the reconfiguration key K_{[0-n]} to reconfigurable logic 910.

Key management unit 930 generates and stores encryption and decryption keys, supplies the public key outside the integrated circuit, and decrypts an encrypted version of the reconfiguration key. In operation, key generator 932 generates a public/private key pair from an unclonable value received from PUF 920 and/or a seed value received from outside the integrated circuit at 931. The keys are stored in storage 936, and the public key is provided outside the integrated circuit as shown at 940. Decryptor 934 receives K_{PUB}, which is a version of the reconfiguration key K_{[0-n]} that has been encrypted using the public key.

Physically unclonable function (PUF) 920 is a physical entity that is embodied in a physical structure that is easy to evaluate but hard to predict. In some embodiments, PUF 920 depends on the uniqueness of its physical microstructure that is influenced by random physical factors introduced during manufacturing. These factors are unpredictable and uncontrollable which makes it virtually impossible to duplicate or clone the structure.

PUF 920 produces an unclonable value that is unique to the integrated circuit in which it resides, and provides that unclonable value to key management unit 930. This results in a different public/private key pair for each instantiation of the integrated circuit.

In some embodiments, the unclonable value is different each time it is evaluated. For example, the unclonable value may be generated once during the lifetime of the integrated circuit, and the public/private key pair may also be generated once and the same copy used for the lifetime of the integrated circuit. In other embodiments, the unclonable value may be repeatable, but only within each integrated circuit such that each instantiation of the integrated circuit still has a unique unclonable value and a unique public/private key pair.

PUF 920 may be any type of PUF, including, but not limited to: an arbiter PUF or a ring oscillator PUF.

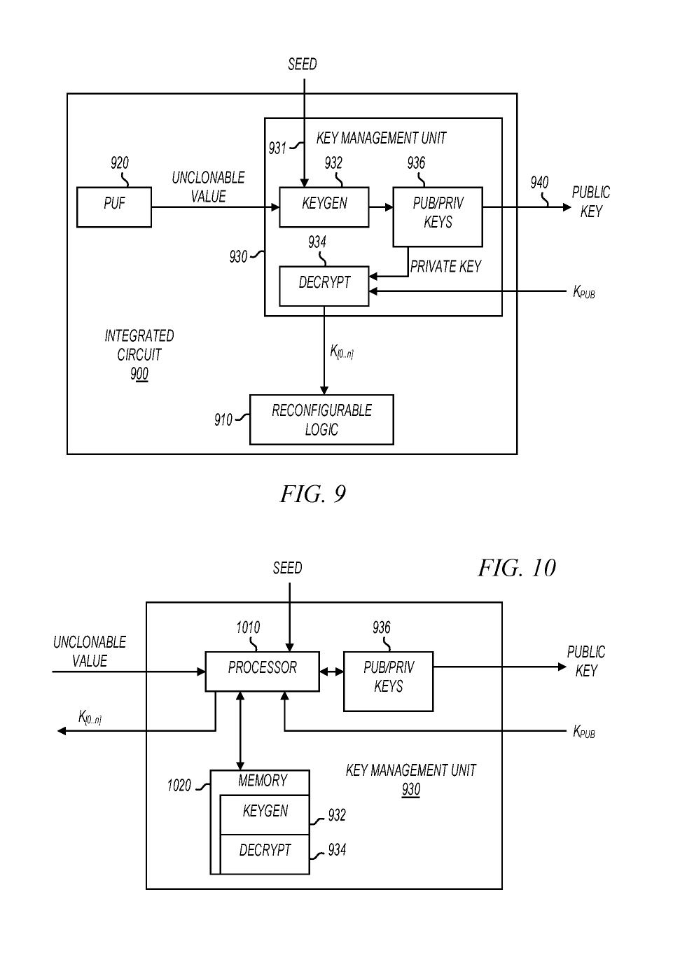

FIG. 10 shows a key management unit. Key management unit 930 is an example implementation that includes a processor 1010 and memory 1020 that includes instructions for key generation 932 and instructions for decryption 934. Other embodiments include dedicated, nonprogrammable hardware to perform the key generation and decryption. In operation, processor 1010 receives an unclonable value and/or a seed value and generates a public/private key pair by executing the keygen instructions 932 held within memory 1020. Processor 1010 also receives K_{PUB} and decrypts the reconfiguration key K_{[0-n]} by executing the decrypt instructions 934 held within memory 1020.

Although FIG. 10 shows a processor implementing some of the functions of key management unit 930, this is not a limitation of the present invention. For example, other embodiments include dedicated, nonprogrammable hardware to perform the key generation and decryption.

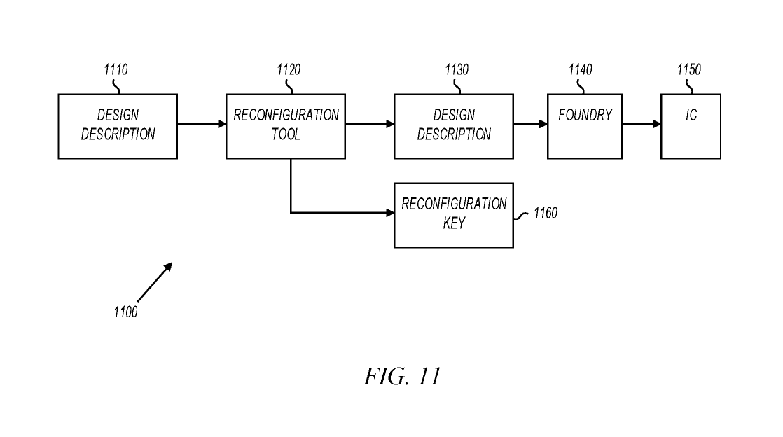

FIG. 11 shows a design process for an integrated circuit that includes reconfigurable logic. Process 1100 starts with a first design description 1110. Design description 1110 may be a typical design description that results from a computer aided design tool. Design description 1110 may be at any level of abstraction. For example, design description 1110 may be a register transfer level (RTL) description, a gate level description, or any other description.

Reconfiguration tool 1120 is a software tool that reads the first design description 1110, and alters the design description to include reconfigurable logic blocks, reconfigurable logic cells, and a key management unit. For example, reconfiguration tool may partition logic into blocks and implement those blocks as sums of products or products of sums using reconfigurable logic cells 100. The resulting reconfigurable logic is represented at 910 in FIG. 9. The output of reconfiguration tool 1120 includes a second design description that includes reconfigurable logic and a key management unit such as key management unit 930 (FIG. 9), and a reconfiguration key 1160. When selection bits K within the reconfiguration key 1160 are applied to the reconfigurable logic within the second design description 1130, the second design description 1130 is logically equivalent to the first design description 1110.

The second design description 1130 is then sent to a foundry 1140 for integrated circuit (IC) 1150 fabrication. The second design description 1130 includes reconfigurable logic cells and blocks that obfuscate the intended operation of the integrated circuit. Nefarious actors that have access to the second design description 1130 do not have access to the first design description 1110, and intellectual property (IP) within the first design description 1110 is therefore protected.

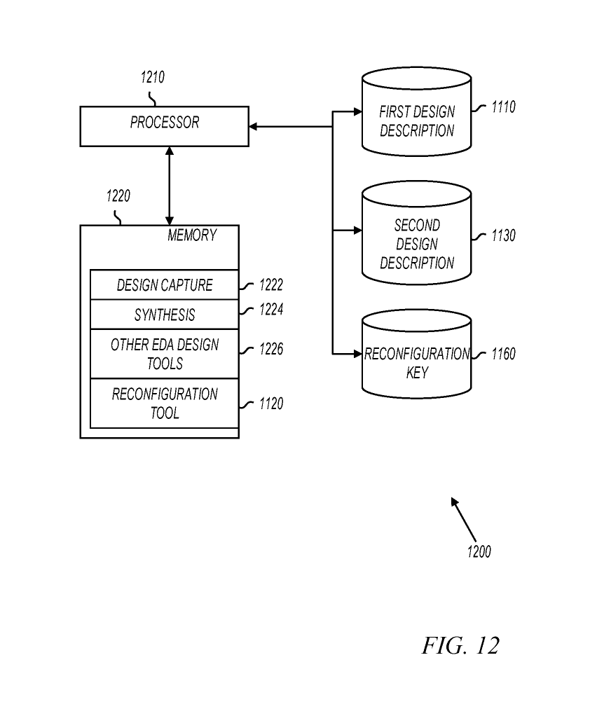

FIG. 12 shows an example electronic design automation (EDA) computer system for designing integrated circuits with reconfigurable logic. EDA computer system 1200 includes processor 1210, memory 1220, first design description 1110, second design description 1130, and reconfiguration key 1160. Design descriptions 1110 and 1130, and reconfiguration key 1160 are shown separately, but in some embodiments, they are housed in the same storage device such as a hard disk drive.

Processor 1210 may be any type of processor, including a microprocessor, a digital signal processor, or the like. Memory 1220 may be any type of non-transitory storage medium capable of storing instructions that can be executed by processor 1210. For example, memory 1220 may be static random access memory (SRAM), dynamic random access memory (DRAM), or any other type of solid state or magnetic memory.

Memory 1220 is shown having instructions for multiple electronic design automation (EDA) tools. For example, memory 1220 includes instructions for design capture 1222, synthesis 1224, other EDA tools 1226, and reconfiguration tool 1120. Design capture 1222 allows a user to capture a design description. In some embodiments, design capture 1222 includes schematic capture and/or behavioral coding tools. Synthesis 1224 generates a lower level representation of the design that is received from the design capture tools 1222. Other EDA design tools 1226 may include any number or type of additional EDA tools. Examples include simulation, layout, design libraries, and the like. First design description 1110 is the result of the design process using tools 1222, 1224, and 1226.

Reconfiguration tool 1120 reads first design description 1110, modifies it, and writes out second design description 1130 and reconfiguration key 1160. Reconfiguration tool 1120 parses the combinational logic within the first design description and partitions it into blocks that can be implemented using reconfigurable logic cells and reconfigurable logic blocks. Reconfiguration tool 1120 also adds a key management unit and a PUF to the second design description.

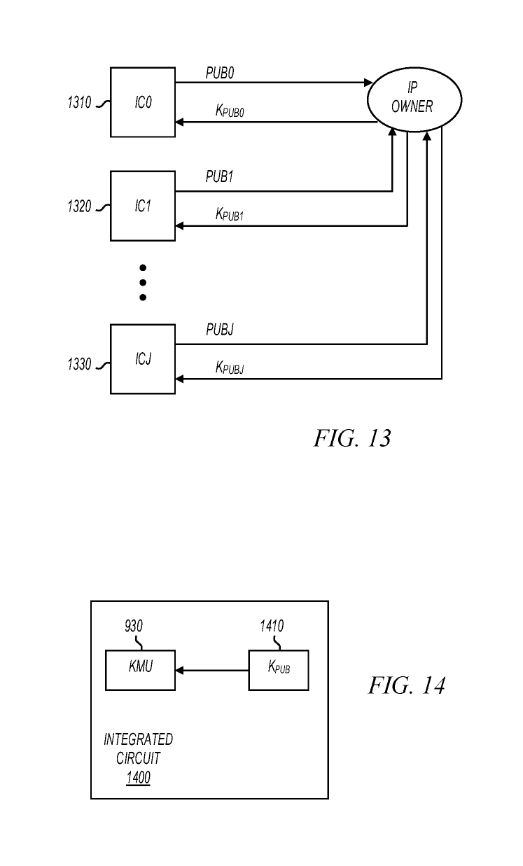

FIG. 13 shows an Intellectual Property owner providing encrypted reconfiguration keys to integrated circuits. FIG. 13 shows [J+1] integrated circuits, where J is an integer. Three of the [J+1] integrated circuits (1310, 1320, 1330) are depicted in the figure. Each of the integrated circuits communicates with the IP owner or a service that operates on behalf of the IP owner. Each integrated circuit provides a unique public key PUB[0-J] to the IP owner, and the IP owner provides an encrypted reconfiguration key KPUB[0-J] encrypted using the unique public key.

In some embodiments, the integrated circuits are installed in end user systems at the time that the interaction shown in FIG. 13 takes place. In other embodiments, the integrated circuits are in a test facility at the time that the interaction shown in FIG. 13 takes place. Public keys and encrypted reconfiguration keys may be communicated over any medium. For example, in some embodiments, public keys and encrypted reconfiguration keys are communicated over a secure network, and in other embodiments, public keys and encrypted reconfiguration keys are communicated over the Internet.

The IP owner depicted in FIG. 13 corresponds to an entity or service that has control over the reconfiguration key (1160, FIG. 11) generated as part of the design reconfiguration described above.

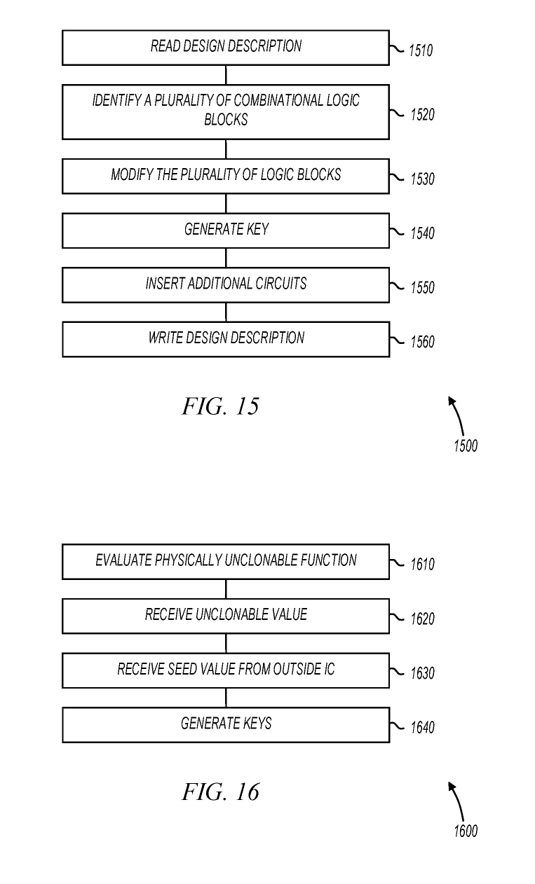

FIG. 14 shows an integrated circuit with embedded storage for an encrypted reconfiguration key. Integrated circuit 1400 represents any of the integrated circuits that include a key management unit as described herein. Integrated circuit 1400 includes key management unit (KMU) 930, and also includes embedded storage 1410 to store the encrypted reconfiguration key.

In embodiments represented by FIG. 14, the integrated circuit may provide the unique public key and receive the encrypted reconfiguration key only once when the integrated circuit is first powered, and thereafter may retrieve the reconfiguration key from embedded storage 1410. In other embodiments, the integrated circuit may periodically refresh the contents of embedded storage 1410 by providing the public key and receiving the encrypted reconfiguration key as shown in FIG. 13. Other embodiments omit embedded storage 1410 and receive the encrypted reconfiguration key each time the integrated circuit is powered.

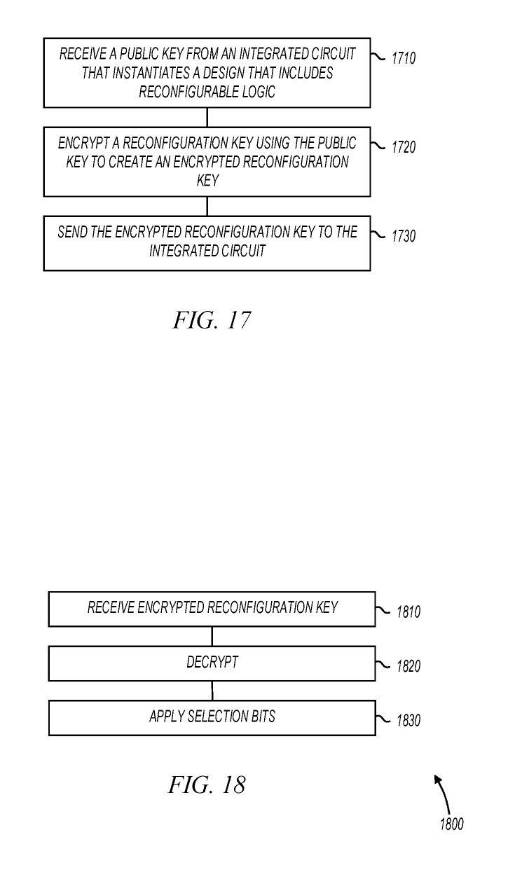

FIG. 15 shows a flowchart of methods in accordance with various embodiments of the present invention. In some embodiments, method 1500 is performed by an EDA reconfiguration tool in accordance with various embodiments of the present invention. The various actions in method 1500 may be performed in the order presented, in a different order, or simultaneously. Further, in some embodiments, some actions listed in FIG. 15 are omitted from method 1500.

Method 1500 begins at 1510 in which a first design description is read. In some embodiments, this corresponds to reconfiguration tool 1120 (FIGS. 11, 12) reading first design description 1110 (FIGS. 11, 12). At 1520, method 1500 identifies a plurality of combinational logic blocks. In some embodiments, each of these combinational logic blocks may be implemented by a sum-of-products or a product-of-sums. At 1530, the plurality of logic blocks are modified by including reconfigurable logic cells and reconfigurable logic blocks as described above. At 1540, method 1500 generates a reconfiguration key that when applied to the newly modify logic blocks, maintains the logical function of the first design description. At 1550, additional circuits are inserted into the design description. In some embodiments, this includes inserting a key management unit and a PUF as described above.

At 1560, method 1500 writes a second description that includes reconfigurable logic, a key management unit, and a PUF. In some embodiments, this corresponds to reconfiguration tool 1120 (FIGS. 11, 12) writing second design description 1130 and reconfiguration key 1160 (FIGS. 11, 12).

FIG. 16 shows a flowchart of methods in accordance with various embodiments of the present invention. In some embodiments, method 1600 is performed by an integrated circuit that includes reconfigurable logic in accordance with various embodiments of the present invention. In other embodiments, method 1600 is performed by a key management unit within an integrated circuit. The various actions in method 1600 may be performed in the order presented, in a different order, or simultaneously. Further, in some embodiments, some actions listed in FIG. 16 are omitted from method 1600.

Method 1600 begins at 1610 in which a physically unclonable function is evaluated. In some embodiments, this corresponds to PUF 920 (920, FIG. 9) evaluating an internal function and producing an unclonable value. At 1620, an unclonable value is received. In some embodiments, this corresponds to key management unit 930 receiving an unclonable value from PUF 920 (FIG. 9). At 1630, a seed value is received from outside the integrated circuit. The seed may be provided by any device or entity. For example, in some embodiments, a seed may be provided by the integrated circuit designer or the end user of the integrated circuit. At 1640, keys are generated. In some embodiments, this corresponds to the generation of a public/private key pair as described above. Each instantiation of the integrated circuit design will have a unique public/private key pair because of the differences in the unclonable value in each integrated circuit.

FIG. 17 shows a flowchart of methods in accordance with various embodiments of the present invention. In some embodiments, method 1700 is performed by an intellectual property owner or a processing system on behalf of an intellectual property owner in accordance with various embodiments of the present invention. The various actions in method 1700 may be performed in the order presented, in a different order, or simultaneously. Further, in some embodiments, some actions listed in FIG. 17 are omitted from method 1700.

Method 1700 begins at 1710 in which a public key is received from an integrated circuit that instantiates a design that includes reconfigurable logic. In some embodiments, this corresponds to an IP owner or a service operating on behalf of an IP owner receiving a public key such as one of the public keys KPUB[0-J] shown in FIG. 13.

At 1720, a reconfiguration key is encrypted using the public key to create an encrypted reconfiguration key. And at 1730, the encrypted reconfiguration key is sent to the integrated circuit. In some embodiments, these actions correspond to an IP owner or a service operating on behalf of the IP owner encypting a reconfiguration key and sending it to an integrated circuit as described above with respect to FIG. 13.

FIG. 18 shows a flowchart of methods in accordance with various embodiments of the present invention. In some embodiments, method 1800 is performed by an integrated circuit that includes reconfigurable logic in accordance with various embodiments of the present invention. The various actions in method 1800 may be performed in the order presented, in a different order, or simultaneously. Further, in some embodiments, some actions listed in FIG. 18 are omitted from method 1800.

Method 1800 begins at 1810 in which an encrypted reconfiguration key is received. In some embodiments, this corresponds to an integrated circuit receiving K_{PUB} as shown in FIGS. 9 and 10. At 1820, the encrypted reconfiguration key is decrypted, and at 1830, the selection bits included within the reconfiguration key are applied to reconfigurable logic within the integrated circuit.

The following paragraphs provide further disclosure of various invention embodiments. Each embodiment is fully defined by the recitation of the corresponding paragraph, and no other elements are to be considered essential for that particular embodiment. The embodiments include:

A. A reconfigurable logic block comprising:

a plurality of cells, wherein each of the plurality of cells conditionally implements a NAND function or a NOR function, each of the plurality of cells comprising a selection mechanism coupled to select the NAND function or the NOR function, wherein the plurality of cells are arranged in a manner such that the selection mechanism configures the reconfigurable logic block to implement either a sum of products or a product of sums.

A1. The reconfigurable logic block of A wherein the selection mechanism in each of the plurality of cells is coupled to be responsive to a common selection signal.
A2. The reconfigurable logic block of A wherein each of the plurality of cells comprises a NAND gate in parallel with a NOR gate.
A3. The reconfigurable logic block of A2 wherein the NAND gate and the NOR gate comprise NMOS transistors.
A4. The reconfigurable logic block of A2 wherein the NAND gate and the NOR gate comprise PMOS transistors.
B. An integrated circuit comprising:

a plurality of reconfigurable logic blocks, each capable of implementing either a sum of products or a product of sums based on states of selection bits; and

a key management unit to provide the selection bits to the plurality of reconfigurable logic blocks.

B1. The integrated circuit of B wherein the key management unit comprises a physically unclonable function.
B2. The integrated circuit of B1 wherein the key management unit includes secure storage for a private key derived from a value provided by the physically unclonable function.
B3. The integrated circuit of B2 wherein the key management unit is configured to receive an encrypted reconfiguration key, decrypt the reconfiguration key using the private key, and provide selection bits to the plurality of reconfigurable logic blocks.
B4. The integrated circuit of B wherein each of the plurality of reconfigurable logic blocks includes a plurality of cells, wherein each of the plurality of cells comprises a NAND gate in parallel with a NOR gate, and a selection mechanism responsive to a selection bit coupled to select the NAND gate or the NOR gate.
C. An integrated circuit comprising:

a plurality of reconfigurable logic blocks, each including a plurality of cells that implement either a NAND function or a NOR function based on a state of a selection bit; and

a key management unit to provide a plurality of selection bits to the plurality of reconfigurable logic blocks.

C1. The integrated circuit of C wherein the key management unit comprises a physically unclonable function.
C2. The integrated circuit of C1 wherein the key management unit includes secure storage for a private key derived from a value provided by the physically unclonable function.
C3. The integrated circuit of C2 wherein the key management unit is configured to receive an encrypted reconfiguration key, decrypt the reconfiguration key using the private key, and provide selection bits to the plurality of reconfigurable logic blocks.
C4. The integrated circuit of C wherein each of the plurality of cells comprises a NAND gate in parallel with a NOR gate, and a selection mechanism responsive to the selection bit coupled to select the NAND gate or the NOR gate.
D. An Electronic Design Automation (EDA) tool that performs a method comprising the steps of:

reading an integrated circuit design representation;

identifying a plurality of combinational logic blocks within the integrated circuit design representation;

modifying the integrated circuit design representation to implement at least one of the plurality of combinational logic blocks as either a sum of products or a product of sums in response to selection bits; and

generating a key that includes the selection bits.

D1. The EDA tool of D wherein modifying the integrated circuit design representation comprises replacing the at least one of the plurality of combination logic blocks with configurable gates that can function as either NAND gates or NOR gates in response to the selection bits.
D2. The EDA tool of D wherein the tool further performs the step of inserting a physically unclonable function into the integrated circuit design representation.
E. A method comprising:

modifying logic blocks in a first integrated circuit design to generate a second integrated circuit design that includes modified logic blocks implemented with either sum-of-product or product-of-sum logic using cells that are configurable based on selection bits.

E1. The method of E wherein the cells that are configurable based on selection bits include parallel selectable NAND and NOR gates.
E2. The method of E further comprising generating selection bits that when applied to the cells that are configurable render the second integrated circuit design functionally equivalent to the first integrated circuit design.
E3. The method of E further comprising inserting a key management unit into the second integrated circuit design.
E4. The method of E3 wherein the key management unit comprises key generation hardware to generate a private key from a physically unclonable function.
E5. The method of E4 wherein the key management unit further comprises decryption hardware to decrypt a key that includes the selection bits.
E6. The method of E further comprising inserting a physically unclonable function in the second integrated circuit design.
E7. The method of E6 further comprising inserting a storage mechanism to store a private key derived from a value provided by the physically unclonable function.
E8. The method of E7 further comprising inserting processing hardware into the second integrated circuit design to decrypt the selection bits using the private key.
F. A method performed by an integrated circuit comprising:

receiving an encrypted key that includes selection bits;

decyrpting the encrypted key using a private key derived from a value provided by a physically unclonable function within the integrated circuit;

applying the selection bits to reconfigurable logic blocks to make the reconfigurable logic blocks operate as either a sum of products or a product of sums.

F1. The method of F further comprising:

deriving the private key from the value provided by the physically unclonable function.

F2. The method of F1 further comprising:

deriving a public key from the private key; and

providing the public key outside the integrated circuit.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

1. A reconfigurable logic block comprising:
a plurality of cells, wherein each of the plurality of cells conditionally implements a NAND function or a NOR function, each of the plurality of cells comprising a selection mechanism coupled to select the NAND function or the NOR function, wherein the plurality of cells are arranged in a manner such that the selection mechanism configures the reconfigurable logic block to implement either a sum of products or a product of sums.

2. The reconfigurable logic block of claim 1 wherein the selection mechanism in each of the plurality of cells is coupled to be responsive to a common selection signal.

3. The reconfigurable logic block of claim 1 wherein each of the plurality of cells comprises a NAND gate in parallel with a NOR gate.

4. The reconfigurable logic block of claim 3 wherein the NAND gate and the NOR gate comprise NMOS transistors.

5. The reconfigurable logic block of claim 3 wherein the NAND gate and the NOR gate comprise PMOS transistors.

6-18. (canceled)
